(19) United States
(12) Patent Application Publication
(10) Pub. No.: US 2010/0020888 A1
(43) Pub. Date: Jan. 28, 2010

(54) COMMUNICATION SYSTEM, COMMUNICATION METHOD AND INFORMATION RECORDING MEDIUM

(76) Inventor: Ken Umeno, Tokyo (JP)

Correspondence Address: HOWARD & HOWARD ATTORNEYS PLLC, 450 West Fourth Street, Royal Oak, MI, 48067, US

(21) Appl. No.: 12/306,482

(22) PCT Filed: Dec. 27, 2007
(86) PCT No.: PCT/JP2007/075130

§ 371 Date: Sep. 10, 2009

(30) Foreign Application Priority Data
Dec. 28, 2006 (JP) 2006-355101

(51) Int. Cl. H04L 27/00; H04L 27/06

(52) U.S. Cl. 375/259; 375/343

(57) ABSTRACT

In order to transmit and receive not less than a binary digital signal using a code table in which chaotic map is used and an independent component analysis, a transmitting device (121) and a receiving device (141) of a communication system (101) use the same chaos function T(•) and the same applying function A(•, •) to generate and hold a corresponding table that makes a sequence of a predetermined length correspond to each of bit sequences of a predetermined length as a code by using a code table generating device (161). The transmitting device (121) modulates a code corresponding to a bit sequence to be transmitted for transmission and the receiving device (141) performs an independent component analysis of signals received by a plurality of antennas to identify a signal of an analysis result with the maximum correlation with a code contained in the corresponding table as a signal transmitted from the transmitting device (121) and outputs a bit sequence corresponding to a code with the maximum correlation with the identified signal of the analysis result in the code table as a transmitted signal.

### TECHNICAL FIELD

The present invention relates to a communication system and a communication method which transmit and receive a digital signal of no less than a binary by using a code table in which chaotic map is used and an independent component analysis, and a computer readable information recording medium recording a program that causes a computer to realize these communication system and method.

### BACKGROUND ART

Various technologies regarding digital communication in which chaotic map is applied and various kinds of signal separation have been proposed. In addition, such technologies are disclosed by Patent Literature shown below:

### Patent Literature 1: Unexamined Japanese Patent Application KOKAI Publication No. 2005-51344

### Patent Literature 2: Unexamined Japanese Patent Application KOKAI Publication No. 2001-60937

Here, [Patent Literature 1] discloses a technology to acquire a plurality of signals by receiving radio wave signals transmitted from a plurality of transmitting devices by a plurality of antennas of a receiving device and performing an independent component analysis.

On the other hand, [Patent Literature 2] discloses a technology to directly perform spread spectrum communication using as a spread code a PN sequence generated by using Chebyshev polynomials, which are a kind of chaotic map, as a recurrence formula.

### DISCLOSURE OF INVENTION

### Problem to be Solved by the Invention

In communication technology, however, many communication technologies having different characteristics depending on the field of application are demanded. On the other hand, there is a growing desire to simplify the structure of transmitting devices and receiving devices by using technologies such as chaotic map and an independent component analysis.

The present invention attempts to solve such challenges and an object thereof is to provide a communication system and a communication method which transmit and receive a digital signal of no less than a binary by using a code table in which chaotic map is used and an independent component analysis, and a computer readable information recording medium recording a program that causes a computer to realize these communication system and method.

The present invention is a result of research and development of “Research and Development of ICA Communication Chip”, which is an adopted theme of 2005 Second Industrial Technology Research Support Project by the independent administrative agency of Japan “New Energy and Industrial Technology Development Organization (NEDO)”.

To achieve the above object, the invention below will be disclosed according to principles of the present invention.

A communication system according to a first aspect of the present invention is a communication system that encodes a bit sequence to be transmitted by chaotic map T(•) with a predetermined interval [L, U] defined as a domain and a range, an inverse function F⁻¹(•) of a partial function F(•) of the chaotic map T(•) with a first partial interval in the predetermined interval defined as the domain and the predetermined interval as the range, the first partial interval being a partial interval in which the chaotic map T(•) becomes bijective map, an inverse function G⁻¹(•) of a partial function G(•) of the chaotic map T(•) with a second partial interval in the predetermined interval defined as the domain and the predetermined interval as the range, the second partial interval being a partial interval in which the chaotic map T(•) becomes bijective map, and an applying function A(•, •) defined as

A(0,x)=F⁻¹(x);

A(1,x)=G⁻¹(x)

for bit values of 0 and 1 and has a transmitting device and a receiving device and is constructed as described below.

Each of the code table generating devices has a boundary value computation unit, a numeric value selection unit, a sequence computation unit, and a code table storage unit.

Here, the boundary value computation unit computes, for each of any bit sequences of a length N, boundary values

v_{U}=A(b_{N}, . . . A(b₂,A(b₁,U)) . . . );

v_{L}=A(b_{N}, . . . A(b₂,A(b₁,L)) . . . )

for the bit sequence

b₁,b₂, . . . , b_{N}

The numeric value selection unit, on the other hand, selects a numeric value v contained in an interval whose upper limit is one of the computed boundary values v_{U} and v_{L} and whose lower limit is the other.

Further, the sequence computation unit computes a sequence

a₁,a₂, . . . , a_{N}

from the selected numeric value v by a recurrence formula shown below:

a₁=v;

aᵢ₊₁=T(aᵢ) (1≦i<N)

Then, the code table storage unit stores a code table that makes each of any bit sequences of the length N correspond to a code for the bit sequence

b₁,b₂, . . . , b_{N}

as the computed sequence

a₁,a₂, . . . , a_{N}

The transmitting device has an input unit, a code acquisition unit, and a transmitting unit.

Here, the input unit accepts input of a bit sequence

s₁,s₂, . . . , s_{N}

of the length N to be transmitted.

The code acquisition unit, on the other hand, acquires a code

e₁,e₂, . . . , e_{N}

for the bit sequence

s₁,s₂, . . . , s_{N}

in the code table stored in the code table generating device of the transmitting device.

Further, the transmitting unit modulates and transmits the acquired code

e₁,e₂, . . . , e_{N}

The receiving device has a receiving unit, an independent component analysis unit, a correlation identifying unit, and an output unit.

Here, the receiving unit receives signals including codes transmitted from the transmitting device by a plurality of antennas and demodulated.

The independent component analysis unit, on the other hand, performs an independent component analysis of the signal received and by the plurality of antennas and demodulated into a plurality of independent components.

Further, the correlation identifying unit determines the maximum value of correlation of each of the plurality of independent components with each code contained in the code table stored in the code table storage unit of the receiving device and identifies the independent component whose maximum value of the correlation is the largest as a signal including codes transmitted from the transmitting device.

Then, the output unit outputs a bit sequence associated with the maximum value of correlation determined in the code table stored in the code table generating device for the identified independent component as a bit sequence transmitted from the transmitting device.

A communication system according to the present invention can be constructed so that the predetermined interval [L, U] is [−1, 1], the chaotic map T(•) is defined as

T(x)=2x²−1

by a second order Chebyshev map, and the inverse function F⁻¹(•) and the inverse function G⁻¹(•) are defined as

F⁻¹(y)=[(y+1)/2]^{1/2};

G⁻¹(y)=−[(y+1)/2]^{1/2}

Also, a communication system according to the present invention can be constructed so that the predetermined interval is [−1, 1], the chaotic map T(•) is defined as

T(x)=2x²−1

by a second order Chebyshev map, and the inverse function F⁻¹(•) and the inverse function G⁻¹(•) are defined as

F⁻¹(y)=−[(y+1)/2]^{1/2};

G⁻¹(y)=[(y+1)/2]^{1/2}

Also, a communication system according to the present invention can be constructed so that the transmitting unit of a transmitting device transforms the code

e₁,e₂, . . . , e_{N}

acquired by a transform function m(•) defined as

m(x)=1 (x≧0);

m(x)=−1 (x<0)

into

m(e₁),m(e₂), . . . , m(e_{N}),

and modulates and transmits the transformed code.

Also, a communication system according to the present invention can be constructed so that the transmitting unit in a transmitting device transforms the acquired code

e₁,e₂, . . . , e_{N}

by a transform function m(•) defined as

m(x)=−1 (x≧0);

m(x)=1 (x<0)

into

m(e₁),m(e₂), . . . , m(e_{N}),

and modulates the transformed code for transmission.

A communication system according to another aspect of the present invention is a communication system that encodes a w-valued sequence to be transmitted by: chaotic map T(•), which is w(w≧2)-order Chebyshev polynomial with a predetermined interval [−1, 1] defined as a domain and a range; an inverse function Fᵢ⁻¹(•) of a partial function Fᵢ(•) of the chaotic map T(•) with an i(0≦i<w)-th partial interval Rⱼ in the predetermined interval defined as the domain and the predetermined interval as the range, for w mutually prime partial intervals R₀, R₁, . . . , R_{w-1} (∪ᵢ₌₀^{w-1}Rᵢ=[−1, 1]) in which the chaotic map T(•) becomes bijective map; and an applying function A(•, •) defined as

A(0,x)=F₀⁻¹(x);

A(1,x)=F₁⁻¹(x);

. . . ;

A(i,x)=Fᵢ⁻¹(x);

. . . ;

A(w−1,x)=F_{w-1}⁻¹(x)

for w values 0, 1, . . . , i, . . . , w−1 and has a transmitting device and a receiving device and is constructed as described below.

Each of the code table generating devices has a boundary value computation unit, a numeric value selection unit, a sequence computation unit, and a code table storage unit.

Here, the boundary value computation unit computes, for each of any w-valued sequences of the length N, boundary values

v₋₁=A(b_{N}, . . . A(b₂,A(b₁,−1)) . . . );

v₁=A(b_{N}, . . . A(b₂,A(b₁,1)) . . . )

for the w-valued sequence

b₁,b₂, . . . , b_{N}

The numeric value selection unit, on the other hand, selects a numeric value v contained in an interval whose upper limit is one of the computed boundary values v₁ and v₋₁ and whose lower limit is the other.

Further, the sequence computation unit computes a sequence

a₁,a₂, . . . , a_{N}

from the selected numeric value v by a recurrence formula shown below:

a₁=v;

aᵢ₊₁=T(aᵢ) (1≦i<N)

Then, the code table storage unit stores a code table that associates each of any w-valued sequences of the length N with a code for the w-valued sequence

b₁,b₂, . . . , b_{N}

as the computed sequence

a₁,a₂, . . . , a_{N}

The transmitting device has an input unit, a code acquisition unit, and a transmitting unit.

Here, the input unit accepts input of a w-valued sequence

s₁,s₂, . . . , s_{N}

of the length N to be transmitted.

The code acquisition unit, on the other hand, acquires a code

e₁,e₂, . . . , e_{N}

for the w-valued sequence

s₁,s₂, . . . , s_{N}

in the code table stored in the code table generating device of the transmitting device.

Further, the transmitting unit modulates and transmits the acquired code

e₁,e₂, . . . , e_{N}

The receiving device has a receiving unit, an independent component analysis unit, a correlation identifying unit, and an output unit.

Here, the receiving unit receives signals including codes transmitted from the transmitting device by a plurality of antennas and demodulated.

The independent component analysis unit, on the other hand, performs an independent component analysis of the signal received and by the plurality of antennas and demodulated into a plurality of independent components.

Further, the correlation identifying unit determines the maximum value of correlation of each of the plurality of independent components with each code contained in the code table stored in the code table storage unit of the receiving device and identifies the independent component whose maximum value of the correlation is the largest as a signal including codes transmitted from the transmitting device.

Then, the output unit outputs a w-valued sequence associated with the maximum value of correlation determined in the code table stored in the code table generating device for the identified independent component as a w-valued sequence transmitted from the transmitting device.

Also, a communication system according to the present invention can be constructed so that the transmitting unit in a transmitting device transforms the acquired code

e₁,e₂, . . . , e_{N}

by a transform function m(•) defined as

m(x)=rᵢ(xεRᵢ)

by a representative value rᵢεRᵢ determined in advance for each of the partial intervals Rᵢ into

m(e₁),m(e₂), . . . , m(e_{N}),

and modulates the transformed code for transmission.

Also, a communication system according to the present invention can be constructed so that the transmitting device transmits a signal to be transmitted by dividing it into portions of the length N and the receiving device determines the maximum value of correlation of each of the plurality of independent components with the code by dividing the independent component into sequences of the length N to identify the independent component with the largest sum of the determined maximum values of correlation as a signal including codes transmitted from the transmitting device.

A communication method according to still another aspect of the present invention is a communication method performed in a communication system that encodes a bit sequence to be transmitted by chaotic map T(•) with a predetermined interval [L, U] defined as a domain and a range, an inverse function F⁻¹(•) of a partial function F(•) of the chaotic map T(•) with a first partial interval in the predetermined interval defined as the domain and the predetermined interval as the range, the first partial interval being an interval in which the chaotic map T(•) becomes bijective map, an inverse function G⁻¹(•) of a partial function G(•) of the chaotic map T(•) with a second partial interval in the predetermined interval defined as the domain and the predetermined interval as the range, the second partial interval being an interval in which the chaotic map T(•) becomes bijective map, and an applying function A(•, •) defined as

A(0,x)=F⁻¹(x);

A(1,x)=G⁻¹(x)

for bit values of 0 and 1 and has a transmitting device (121) and a receiving device, and each of the transmitting device and receiving device has a code table generating device.

Here, each of the code table generating devices has a boundary value computation step, a numeric value selection unit, a sequence computation unit, and a code table storage unit.

Then, the communication method has a boundary value computation step, a numeric value selection step, a sequence computation step, and a code table storage step in the transmitting device and receiving device.

Here, the boundary value computation step computes, for each of any bit sequences of the length N, boundary values

v_{U}=A(b_{N}, . . . A(b₂,A(b₁,U)) . . . );

v_{L}=A(b₁, . . . A(b₂,A(b₁,L)) . . . )

for the bit sequence

b₁,b₂, . . . , b_{N}

The numeric value selection step, on the other hand, selects a numeric value v contained in an interval whose upper limit is one of the computed boundary values v_{U} and v_{L} and whose lower limit is the other.

Further, the sequence computation step computes a sequence

a₁,a₂, . . . , a_{N}

from the selected numeric value v by a recurrence formula shown below:

a₁=v;

aᵢ₊₁=T(aᵢ) (1≦i<N)

Then, the code table storage step stores a code table that associates each of any bit sequences of the length N with a code for the bit sequence

b₁,b₂, . . . , b_{N}

as the computed sequence

a₁,a₂, . . . , a_{N}

in the code table storage unit.

The transmitting device, on the other hand, has an input unit, a code acquisition unit, and a transmitting unit.

Then, the transmitting method has an input step, a code acquisition step, and a transmitting step in the transmitting device.

Here, in the input step, the input unit accepts input of a bit sequence

s₁,s₂, . . . , s_{N}

of the length N to be transmitted.

In the code acquisition step, on the other hand, the code acquisition unit acquires a code

e₁,e₂, . . . , e_{N}

for the bit sequence

s₁,s₂, . . . , s_{N}

in the code table stored in the code table generating device of the transmitting device.

Further, in the transmitting step, the transmitting unit modulates and transmits the acquired code

e₁,e₂, . . . , e_{N}

Further, the receiving device has a receiving unit, an independent component analysis unit, a correlation identifying unit, and an output unit.

Then, the communication method has a receiving step, an independent component analysis step, a correlation identifying step, and an output step in the receiving device.

Here, in the receiving step, the receiving unit receives signals including codes transmitted from the transmitting device and by a plurality of antennas and demodulated.

In the independent component analysis step, on the other hand, the independent component analysis unit performs an independent component analysis of the signal received by the plurality of antennas and demodulated into a plurality of independent components.

Further, in the correlation identifying step, the correlation identifying unit determines the maximum value of correlation of each of the plurality of independent components with each code contained in the code table stored in the code table storage unit of the receiving device and identifies the independent component whose maximum value of the correlation is the largest as a signal including codes transmitted from the transmitting device.

Then, in the output step, the output unit outputs a bit sequence associated with the maximum value of correlation determined in the code table stored in the code table generating device for the identified independent component as a bit sequence transmitted from the transmitting device.

A communication method according to the present invention can be constituted so that the predetermined interval [L, U] is [−1, 1], the chaotic map T(•) is defined as

T(x)=2x²−1

by a second order Chebyshev map, and the inverse function F⁻¹(•) and the inverse function G⁻¹(•) are defined as

F⁻¹(y)=[(y+1)/2]^{1/2};

G⁻¹(y)=−[(y+1)/2]^{1/2}

Also, a communication method according to the present invention can be constituted so that the predetermined interval is [−1, 1], the chaotic map T(•) is defined as

T(x)=2x²−1

by a second order Chebyshev map, and the inverse function F⁻¹(•) and the inverse function G⁻¹(•) are defined as

F⁻¹(y)=−[(y+1)/2]^{1/2};

G⁻¹(y)=[(y+1)/2]^{1/2}

Also, a communication method according to the present invention can be constituted so that in the transmitting step of a transmitting device, the acquired code

e₁,e₂, . . . , e_{N}

is transformed by a transform function m(•) defined as

m(x)=1 (x≧0);

m(x)=−1 (x<0)

into

m(e₁),m(e₂), . . . , m(e_{N}),

and modulated and transmitted.

Also, a communication method according to the present invention can be constituted so that in the transmitting step of a transmitting device, the acquired code

e₁,e₂, . . . , e_{N}

is transformed by a transform function m(•) defined as

m(x)=−1 (x≧0);

m(x)=1 (x<0)

into

m(e₁),m(e₂), . . . , m(e_{N}),

and modulated for transmission.

A communication method according to still another aspect of the present invention is a communication method performed in a communication system that encodes a bit sequence to be transmitted by: chaotic map T(•), which is w(w≧2)-order Chebyshev polynomial with a predetermined interval [−1, 1] defined as a domain and a range; an inverse function Fᵢ⁻¹(•) of a partial function Fᵢ(•) of the chaotic map T(•) with an i(0≦i<w)-th partial interval Rⱼ in the predetermined interval defined as the domain and the predetermined interval as the range, for w mutually prime partial intervals R₀, R₁, . . . , R_{w-1} (∪ᵢ₌₀^{w-1}Rᵢ=[−1, 1]) in which the chaotic map T(•) becomes bijective map; and an applying function A(•, •) defined as

A(0,x)=F₀⁻¹(x);

A(1,x)=F₁⁻¹(x);

. . . ;

A(i,x)=Fᵢ⁻¹(x);

. . . ;

A(w−1,x)=F_{w-1}⁻¹(x)

for w values 0, 1, . . . , i, . . . , w−1 and has a transmitting device (121) and a receiving device, and each of the transmitting device and receiving device has a code table generating device.

Here, each of the code table generating devices has a boundary value computation unit, a numeric value selection unit, a sequence computation unit, and a code table storage unit.

The communication method has a boundary value computation step, a numeric value selection step, a sequence computation step, and a code table storage step in the transmitting device and receiving device.

Here, in the boundary value computation step, the boundary value computation unit computes, for each of any w-valued sequences of the length N, boundary values

v₋₁=A(b_{N}, . . . A(b₂,A(b₁,−1)) . . . );

v₁=A(b_{N}, . . . A(b₂,A(b₁,1)) . . . )

for the w-valued sequence

b₁,b₂, . . . , b_{N}

In the numeric value selection step, on the other hand, the numeric value selection unit selects a numeric value v contained in an interval whose upper limit is one of the computed boundary values v₋₁ and v₁ and whose lower limit is the other.

Further, in the sequence computation step, the sequence computation unit computes a sequence

a₁,a₂, . . . , a_{N}

from the selected numeric value v by a recurrence formula shown below:

a₁=v;

aᵢ₊₁=T(aᵢ) (1≦i<N)

Then, in the code table storage step, a code table that makes each of any w-valued sequences of the length N correspond to a code for the w-valued sequence

b₁,b₂, . . . , b_{N}

is stored as the computed sequence

a₁,a₂, . . . , a_{N}

in the code table storage unit.

The transmitting device, on the other hand, has an input unit, a code acquisition unit, and a transmitting unit.

Then, the communication method has an input step, a code acquisition step, and a transmitting step in the transmitting device.

Here, in the input step, the input unit accepts input of a w-valued sequence

s₁,s₂, . . . , s_{N}

of the length N to be transmitted.

In the code acquisition step, on the other hand, the code acquisition unit acquires a code

e₁,e₂, . . . , e_{N}

for the w-valued sequence

s₁,s₂, . . . , s_{N}

in the code table stored in the code table generating device of the transmitting device.

Further, in the transmitting step, the transmitting unit modulates and transmits the acquired code

e₁,e₂, . . . , e_{N}

Further, the receiving device has a receiving unit, an independent component analysis unit, a correlation identifying unit, and an output unit.

Then, the communication method has a receiving step, an independent component analysis step, a correlation identifying step, and an output step in the receiving device.

Here, in the receiving step, the receiving unit receives signals including codes transmitted from the transmitting device by a plurality of antennas and demodulated.

In the independent component analysis step, on the other hand, the independent component analysis unit performs an independent component analysis of the signal received by the plurality of antennas and demodulated into a plurality of independent components.

Further, in the correlation identifying step, the correlation identifying unit determines the maximum value of correlation of each of the plurality of independent components with each code contained in the code table stored in the code table storage unit of the receiving device and identifies the independent component whose maximum value of the correlation is the largest as a signal including codes transmitted from the transmitting device.

Then, in the output step, the output unit outputs a w-valued sequence associated with the maximum value of correlation determined in the code table stored in the code table generating device for the identified independent component as a w-valued sequence transmitted from the transmitting device.

Also, a communication method according to the present invention can be constituted so that in the transmitting step of a transmitting device, the acquired code

e₁,e₂, . . . , e_{N}

is transformed by a transform function m(•) defined as

m(x)=rᵢ(xεRᵢ)

by a representative value rᵢεRᵢ determined in advance for each of the partial intervals Rᵢ into

m(e₁),m(e₂), . . . , m(e_{N}),

and modulated for transmission.

Also, a communication method according to the present invention can be constituted so that the transmitting device transmits a signal to be transmitted by dividing it into portions of the length N and the receiving device determines the maximum value of correlation of each of the plurality of independent components with the code by dividing the independent component into sequences of the length N to identify the independent component with the largest sum of the determined maximum values of correlation as a signal including codes transmitted from the transmitting device.

A program according to still another aspect of the present invention is constituted so as to cause a computer to function as each unit of a transmitting device of the above communication system and/or as a receiving device of the communication system.

The program can be recorded in a computer readable information recording medium (including a compact disk, flexible disk, hard disk, magneto optical disk, digital video disk, magnetic tape, or semiconductor memory).

Then, in addition to the information recording medium being distributed and sold independently of the computer, the program itself can be distributed and sold via a computer network such as the Internet.

According to the present invention, a communication system and a communication method which transmit and receive a digital signal of no less than a binary by using a code table in which chaotic map is used and an independent component analysis, and a computer readable information recording medium recording a program that causes a computer to realize these communication system and method can be provided.

### BRIEF DESCRIPTION OF DRAWINGS

FIG. 1 is an explanatory diagram showing a schematic configuration of a communication system according to the present embodiment.

FIG. 2 is an explanatory diagram showing second-order to fifth-order Chebyshev maps as graphs.

FIG. 3 is an explanatory diagram showing a schematic configuration of a code table generating device according to the present embodiment.

FIG. 4 is an explanatory diagram showing a schematic configuration of a transmitting device according to the present embodiment.

FIG. 5 is an explanatory diagram showing a schematic configuration of a receiving device according to the present embodiment.

### EXPLANATIONS OF REFERENCE NUMERALS

101 Communication system
121 Transmitting device
122 Input unit
123 Code acquisition unit
124 Transmitting unit
141 Receiving device
142 Receiving unit
143 Independent component analysis unit
144 Correlation identifying unit
145 Output unit
161 Code table generating device
162 Boundary value computation unit
163 Numeric value selection unit
164 Sequence computation unit
165 Code table storage unit

### BEST MODE FOR CARRYING OUT THE INVENTION

Embodiments of the present invention will be described below. Embodiments described below are intended for explanation and do not limit the scope of the present invention. Therefore, those skilled in the art can adopt embodiments obtained by replacing each component or all components by equivalents thereof and such embodiments are also included in the scope of the present invention.

### First Embodiment

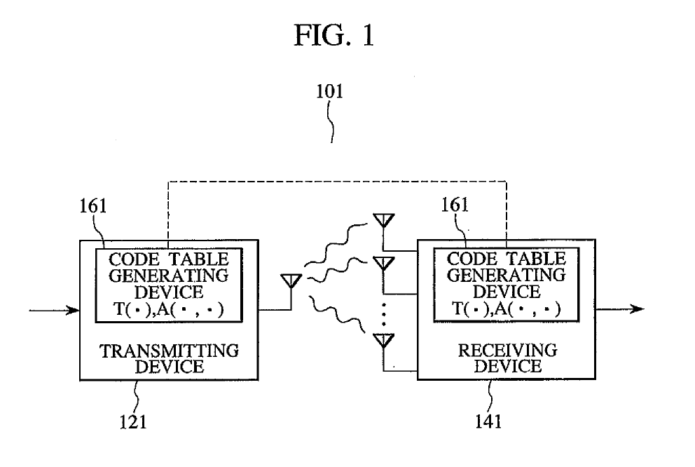

FIG. 1 is an explanatory diagram showing a schematic configuration of a communication system according to the present embodiment. The present embodiment will be described below with reference to FIG. 1.

A communication system 101 according to the present embodiment has a transmitting device 121 and a receiving device 141. Moreover, each of the transmitting device 121 and the receiving device 141 has a code table generating device 161.

Then, in the communication system 101, chaotic map T(•) with a predetermined interval [L, U] defined as a domain and a range is used.

Then, a first partial interval in the predetermined interval is defined as the domain, the first partial interval being an interval in which the chaotic map T(•) becomes bijective map. In the first partial interval, typically the chaotic map T(•) changes monotonously.

Therefore, an inverse function F⁻¹(•) of a partial function F(•) of the chaotic map T(•) with the predetermined interval defined as the range is uniquely determined.

A second partial interval in the predetermined interval is defined as the domain, the second partial interval being an interval in which the chaotic map T(•) becomes bijective map. In the second partial interval, typically the chaotic map T(•) changes monotonously.

Therefore, an inverse function G⁻¹(•) of a partial function G(•) of the chaotic map T(•) with the predetermined interval defined as the range is uniquely determined.

Further, a bit sequence to be transmitted is encoded by using an applying function A(•, •) defined as

A(0,x)=F⁻¹(x);

A(1,x)=G⁻¹(x)

for bit values 0 and 1.

A typical chaotic map of the second order or higher includes a Chebyshev map. Generally, a Chebyshev map of an a-th order is defined as

Tₐ(cos θ)=cos(a θ)

and more concretely, is expanded as polynomials like

T₀(x)=1;

T₁(x)=;

T₂(x)=2x²−1;

T₃(x)=4x³−3x; . . .

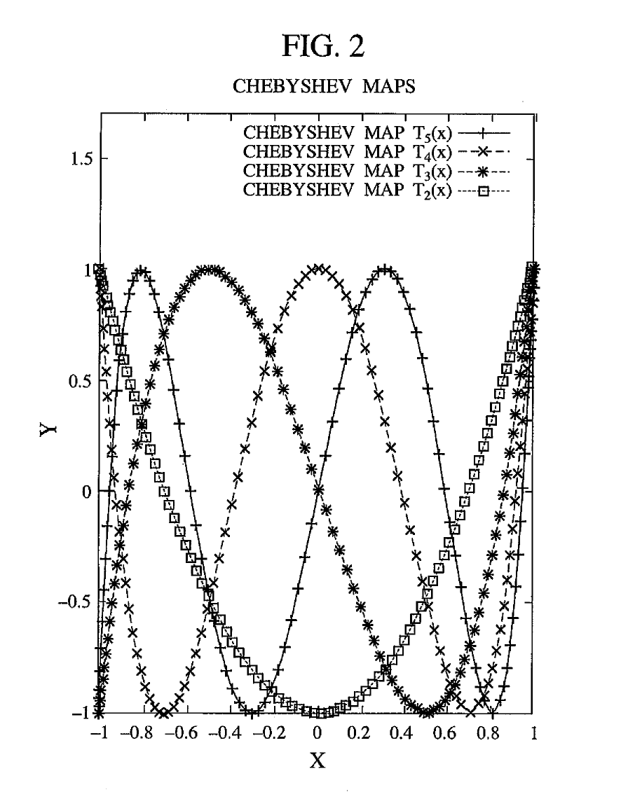

FIG. 2 is an explanatory diagram showing second-order to fifth-order Chebyshev maps as graphs. Chebyshev maps will be described below with reference to FIG. 2.

As shown in FIG. 2, any Chebyshev map y=Tₐ(x) of the a(a≧2)-th order is a rational map that maps a closed interval −1≦x≦1 into the closed interval −1≦y≦1. That is, the interval [−1, 1] is both the domain and range.

When the initial value z₀ is given, a sequence

z₀,z₁,z₂, . . .

determined by a recurrence formula

zᵢ₊₁=Tₐ(zᵢ)

for i≧0 is called a random number sequence of chaotic random numbers.

That is, a sequence of results obtained by repeatedly applying the function Tₐ(•) to an obtained result like a result of applying the Tₐ(•) to the initial value z₀ is z₁, a result of applying the Tₐ(•) to the initial value z₁ is z₂ and so on is a random number sequence of chaotic random numbers.

The same random number sequence can be obtained by sharing the order a of the Chebyshev map and the initial value z₀ when chaotic random numbers are generated.

An example in which a second-order Chebyshev map is used as a chaotic map will be described below, but other chaotic maps may also be applied in the present invention.

That is, in the communication system 101, the predetermined interval [L, U] is [−1, 1] and the chaotic map T(•) is defined as

T(x)=2x²−1

by a second-order Chebyshev map.

The first partial interval and the second partial interval, on the other hand, can be considered as −1≦x<0 and 0≦x<1 (or −1≦x≦0 and 0<x≦1 by shifting the boundary). Since mapping of the first partial interval and the second partial interval is optional, the inverse function F⁻¹(•) and the inverse function G⁻¹(•) may be defined as

F⁻¹(y)=[(y+1)/2]^{1/2};

G⁻¹(y)=−[(y+1)/2]^{1/2}

or

F⁻¹(y)=−[(y+1)/2]^{1/2};

G⁻¹(y)=[(y+1)/2]^{1/2}

The domain of the inverse function F⁻¹(•) and that of the inverse function G⁻¹(•) are −1≦y≦1, which matches the predetermined interval.

(Code Table Generating Device)

The transmitting device 121 and the receiving device 141 have the code table generating device 161 of the same constitution.

The code table generating device 161 is used to make any bit sequence of the length N

b₁,b₂, . . . , b_{N}

to a sequence of the length N

a₁,a₂, . . . , a_{N}

and the correspondence is called a code table.

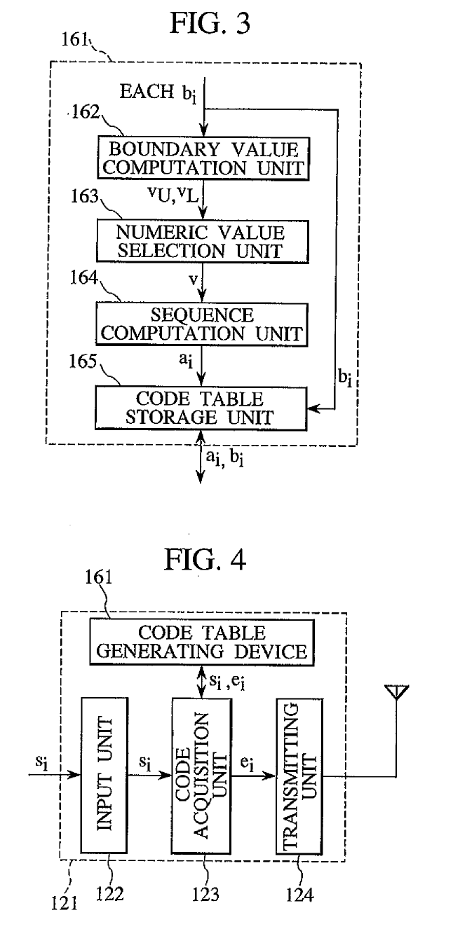

FIG. 3 is an explanatory diagram showing a schematic configuration of the code table generating device 161. The code table generating device 161 will be described below with reference to FIG. 3.

The code table generating device 161 has a boundary value computation unit 162, a numeric value selection unit 163, a sequence computation unit 164, and a code table storage unit 165.

Here, the boundary value computation unit 162 computes, for each of any bit sequences of the length N, boundary values

v_{U}=A(b_{N}, . . . A(b₂,A(b₁,U)) . . . );

v_{L}=A(b_{N}, . . . A(b₂,A(b₁,L)) . . . )

for the bit sequence

b₁,b₂, . . . , b_{N}.

Here, [L, U]=[−1, 1] applies in the present embodiment.

The applying function A(•, •) is defined as

A(0,x)=F⁻¹(x);

A(1,x)=G⁻¹(x)

as described above, and application of one of F⁻¹(x) and G⁻¹(x) is repeated depending on whether b₁, b₂, . . . , b_{N} are 0 or 1.

The type of function repeatedly applied to L and U and the order thereof are common and therefore, the interval sandwiched by two values v_{L} and v_{U} is made narrower each time the function is applied. Moreover, if the corresponding bit sequence

b₁,b₂, . . . , b_{N}

is different, the interval sandwiched by two values v_{L} and v_{U} is also different, producing mutually non-overlapping intervals.

Thus, the numeric value selection unit 163 selects a numeric value v contained in an interval obtained by setting one of boundary values v_{U} and v_{L} computed for each bit sequence

b₁,b₂, . . . , b_{N}

as the upper limit and the other as the lower limit.

The simplest method of selecting the numeric value v is to compute a simple average of v_{U} and v_{L}, but the numeric value v may randomly selected from the interval sandwiched by these two values (an interval excluding two numeric values of boundary values) or a weighted average of the two values.

Further, the sequence computation unit 164 computes a sequence

a₁,a₂, . . . , a_{N}

from the selected numeric value v by a recurrence formula shown below:

a₁=v;

aᵢ₊₁=T(aᵢ) (1≦i<N)

Then, the code table storage unit 165 stores a code table that makes each of any bit sequences of the length N correspond to a code for the bit sequence

b₁,b₂, . . . , b_{N}

as the computed sequence

a₁,a₂, . . . , a_{N}

If encoding of signals based on the code table is adopted, as will be described later, experiments by the inventors have shown that a desired signal can easily be separated by an independent component analysis. Thus, such a code table is adopted in the present embodiment.

(Transmitting Device)

FIG. 4 is an explanatory diagram showing a schematic configuration of the transmitting device 121 of the communication system 101 according to the present embodiment. The transmitting device 121 will be described below with reference to FIG. 4.

In addition to the code table generating device 161, the transmitting device 121 has an input unit 122, a code acquisition unit 123, and a transmitting unit 124.

Here, the input unit 122 accepts input of a bit sequence

s₁,s₂, . . . , s_{N}

of the length N to be transmitted.

The code acquisition unit 123, on the other hand, acquires a code

e₁,e₂, . . . , e_{N}

for the bit sequence

s₁,s₂, . . . , s_{N}

in the code table (a generation table generated in advance using a chaotic function common to the receiving device 141) stored in the code table generating device 161 of the transmitting device 121.

Further, the transmitting unit 124 modulates and transmits the acquired code

e₁,e₂, . . . , e_{N}.

At this point, the code is typically transmitted by a radio wave on an appropriate carrier.

Since the code

e₁,e₂, . . . , e_{N}

is a real-number sequence, the following techniques can be considered as techniques of modulation and transmission:

(a) A technique to transmit real numbers as they are and, for example, a technique for amplitude modulation or frequency modulation

(b) A technique to transmit after converting real numbers into positive/negative codes. Though information is lost from real numbers, lost information can be restored on the receiving side by adopting a chaotic function and independent component analysis. This is one of the important features of the present invention. A typical technique of conversion into positive/negative codes is to use

m(x)=1 (x≧0);

m(x)=−1 (x<0)

or

m(x)=−1 (x≧0);

m(x)=1 (x<0)

as a transform function m(•) when converting

e₁,e₂, . . . , e_{N}

into

m(e₁),m(e₂), . . . , m(e_{N})

After conversion into positive/negative codes, various kinds of modulation such as phase modulation can be applied.

(c) A technique of modulation and transmission after appropriate digitalization of real numbers. For example, a technique can be considered that, after combining with the technique in (b), further applies encoding such as BPSK, QPSK, 8PSK, 16QAM, and 64QAM and performs phase amplitude modulation before transmission.

When a bit sequence of an optional length should be transmitted, a signal may be transmitted by being divided into portions of N bits. At this point, the receiving device 141 combines bit sequences transmitted by being divided into portions of N bits so that a transmitted bit length of the optional length can be obtained.

(Receiving Device)

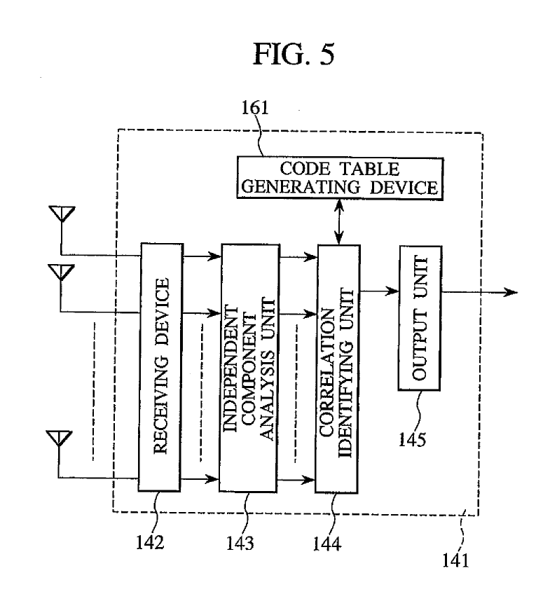

FIG. 5 is an explanatory diagram showing a schematic configuration of the receiving device 141 of the communication system 101 according to the present embodiment. The receiving device 141 will be described below with reference to FIG. 5.

In addition to the code table generating device 161, the receiving device 141 has a receiving unit 142, an independent component analysis unit 143, a correlation identifying unit 144, and an output unit 145.

Here, the receiving unit 142 receives signals including codes transmitted from the transmitting device 121 by a plurality of antennas and demodulated. This is because a plurality of inputs is needed to perform an independent component analysis. The number of antennas can optionally be changed and when communication should be performed with a plurality of the transmitting devices 121 by the receiving device 141, at least as many antennas as the number of the transmitting devices 121 need to be provided.

Processing in reverse to that for modulation and transmission performed by the transmitting unit 124 of the transmitting device 121 such as extraction of a signal from carriers and demodulation, which is the reverse of modulation, needs to be performed, but there is not necessarily a need to obtain a real-number sequence (the above technique (a)) and a positive/negative code sequence of −1 and 1 (the above techniques (b) and (c)) may be sufficient.

The independent component analysis unit 143, on the other hand, performs an independent component analysis of signals received by the plurality of antennas and demodulated into a plurality of independent components. Typically, as many signals as antennas are obtained as a result of analysis.

Further, the correlation identifying unit 144 determines the maximum value of correlation of each of the plurality of independent components with each code contained in the code table stored in the code table generating device 161 of the receiving device 141 and identifies the independent component whose maximum value of the correlation is the largest as a signal including codes transmitted from the transmitting device 121.

One of independent components output by the independent component analysis unit 143 corresponds to a signal transmitted from the transmitting device 121 and other independent components correspond to so-called noise or the like and thus, by determining correlations with each code (length N) contained in the same code table as that used in the transmitting device 121, which output corresponds to a signal output from the transmitting device 121 can be known. When signals of optional lengths are transmitted from the transmitting device 121, the maximum value of correlation can be determined while signals being synchronized by the sliding method in the correlation identifying unit 144.

In fact, signals can also be synchronized by demodulation/reception processing of the receiving unit 142.

Then, the output unit 145 outputs a bit sequence associated with the maximum value of correlation determined in the code table stored in the code table generating device 161 for the identified independent component as a bit sequence transmitted from the transmitting device 121.

If a bit sequence of an optional length should be transmitted and received, as described above, the transmitting device 121 transmits a signal to be transmitted by dividing it into portions of the length N and the receiving device 141 determines the maximum value of correlation of each of the plurality of independent components with the code by dividing the independent component into sequences of the length N to identify the independent component with the largest sum of the determined maximum values of correlation as a signal including codes transmitted from the transmitting device 121. This also applies to an embodiment described below.

In addition, a technique of performing an independent component analysis after buffering the length MN of each of received signals using a predetermined positive integer M can be considered. In this case, a plurality of independent components of the length MN is obtained and correlations of each of portions of the length N contained in each of independent components are computed. Then, the sum, sum of squares, average or the like of M maximum correlation values obtained from some independent component is used as a likelihood that the independent component is the desired signal.

Then, the independent component with the highest likelihood is considered to be a signal corresponding to a desired transmission signal and the transmission signal is obtained by acquiring a bit sequence associated with the code that takes the maximum correlation value for each of M portions of the length N.

Since the processing is easily parallelized, high-speed processing can be achieved particularly when the processing is constituted by integrated electronic circuits.

(Coexistence of a Plurality of Communications)

In the present embodiment, as described above, the same code table is obtained by adopting the same chaotic function T(•) and partial functions F(•) and G(•) thereof on the transmitting side and receiving side.

Therefore, in order to separate communication among a plurality of users by the present technique, a set of different chaotic functions T(•) and partial functions F(•) and G(•) thereof needs to be provided. For this purpose, techniques described below can be considered.

The first technique is a technique to assign a Chebyshev map of a different order to each communication path (user). This is because the code table is different if the Chebyshev map is different.

Tracking of, for example, a Chebyshev map of the third order

T₃(x)=4x³−3x

shows that when the argument of T₃(•) is changed from −1 to 1, the value thereof monotonously increases from −1 to 1, then monotonously decreases from 1 to −1, and further monotonously increases from −1 to 1. Therefore, each of these three monotonously changing intervals can be adopted as a partial interval.

Then, three partial functions with each of these partial intervals defined as the domain and [−1, 1] as the range can be obtained. Generally, L partial functions can be obtained from a Chebyshev map of the L-th order.

Thus, F(•) and G(•) can be determined, similarly when the Chebyshev map of the second order is adopted, by selecting two partial functions from L partial functions.

The second technique is an extension of the first technique and assigns two partial functions of L partial functions of a Chebyshev map of the L-th order as a set to a different communication path (user). While the number of users is limited to one when the order of a Chebyshev map is three or less, when the order of a Chebyshev map is four or five, two mutually different partial functions can be assigned to each of two communication paths (users).

If partial functions are different, v will also be different so that also code tables can also be distinguishably generated of itself.

An inverse function of a partial function of an L-th order Chebyshev map may not be analytically determinable when the order thereof is large, but the value of the inverse function can easily be determined by the Newton-Raphson method or the like because such a partial function changes monotonously. If a code table is once generated, the code table is only referenced thereafter and thus, no problem will be presented even if computation amount increases somewhat by the use of a method of steepest descent such as the Newton-Raphson method to computer an inverse function of a partial function.

### Second Embodiment

While the above embodiment assumes bit sequences as a signal to be transmitted, generally transmission of w-valued digital signals may also be desired. For example, 16QAM can be considered to be a transmission technique corresponding to a 16-valued digital signal. The present invention deals with such circumstances. In a description that follows, a description of components similar to those in the above embodiment is omitted when appropriate.

First, chaotic map T(•), which is Chebyshev polynomials of the w(w≧2)-th order, with the predetermined interval [−1, 1] defined as the domain and the range is used.

Then, an i(0≦i<w)-th partial interval Rⱼ of w mutually prime partial intervals R₀, R₁, . . . , R_{w-1} (∪ᵢ₌₀^{w-1}Rᵢ=[−1, 1]) of the predetermined interval in which the chaotic map T(•) becomes bijective map is considered. In a Chebyshev map of the third order, as described above, the interval of the monotonously changing domain could be divided into three intervals. That is, these intervals are mutually prime intervals.

These three intervals each correspond to R₀, R₁, and R₂. However, which partial interval to select as Rᵢ can freely be determined if the selection is common to both the transmitting side and receiving side.

Then, a partial function Fᵢ(•) of the chaotic map T(•) with Rᵢ for each i defined as the domain and the predetermined interval as the range is considered. The partial function Fᵢ(•) takes the same value as the chaotic map T(•) in the domain thereof.

Then, an applying function A(•, •) defined from the inverse function Fᵢ⁻¹(•) of the partial function Fᵢ(•) as

A(0,x)=F₀⁻¹(x);

A(1,x)=F₁⁻¹(x);

. . . ;

A(i,x)=Fᵢ⁻¹(x);

. . . ;

A(w−1,x)=F_{w-1}⁻¹(x);

for w values 0, 1, . . . , i, . . . , w−1.

What is binary in the first embodiment is extended to w-valued.

In the code table generating device 161, the boundary value computation unit 162 computes, for each of any w-valued sequences of the length N, boundary values

v₋₁=A(b_{N}, . . . A(b₂,A(b₁,−1)) . . . );

v₁=A(b_{N}, . . . A(b₂,A(b₁,1)) . . . )

for the w-valued sequence

b₁,b₂, . . . , b_{N}

The numeric value selection unit 163, on the other hand, selects a numeric value v contained in an interval whose upper limit is one of the computed boundary values v₁ and v₋₁ and whose lower limit is the other.

Further, the sequence computation unit 164 computes a sequence

a₁,a₂, . . . , a_{N}

from the selected numeric value v by a recurrence formula shown below:

a₁=v;

aᵢ₊₁=T(aᵢ) (1≦i<N)

Then, the code table storage unit 165 stores a code table that makes each of any bit sequences of the length N correspond to a code for the w-valued sequence

b₁,b₂, . . . , b_{N}

as the computed sequence

a₁,a₂, . . . , a_{N}

Like the above embodiment, if the Chebyshev map T(•) and the applying function A(•, •) function are the same and the technique to select the numeric value v in the interval is the same, the same code table is obtained.

The transmitting device 121 and the receiving device 141 are the same except that bit sequences are replaced by w-valued sequences.

That is, the transmitting device 121 has, in addition to the code table generating device 161, the input unit 122, the code acquisition unit 123, and the transmitting unit 124.

Here, the input unit 122 accepts input of a w-valued sequence

s₁,s₂, . . . , s_{N}

of the length N to be transmitted.

The code acquisition unit 123, on the other hand, acquires a code

e₁,e₂, . . . , e_{N}

for the w-valued sequence

s₁,s₂, . . . , s_{N}

in the code table stored in the code table generating device 161 of the transmitting device 121.

Further, the transmitting unit 124 modulates and transmits the acquired code

e₁,e₂, . . . , e_{N}

The receiving device 141, on the other hand, has, in addition to the code table generating device 161, the receiving unit 142, the independent component analysis unit 143, the correlation identifying unit 144, and the output unit 145.

Here, the receiving unit 142 receives signals including codes transmitted from the transmitting device 121 by a plurality of antennas and demodulated.

The independent component analysis unit 143, on the other hand, performs an independent component analysis of signals received by the plurality of antennas and demodulated into a plurality of independent components.

Further, the correlation identifying unit 144 determines the maximum value of correlation of each of the plurality of independent components with each code contained in the code table stored in the code table generating device 161 of the receiving device 141 and identifies the independent component whose maximum value of the correlation is the largest as a signal including codes transmitted from the transmitting device 121.

Then, the output unit 145 outputs a w-valued sequence associated with the maximum value of correlation determined in the code table stored in the code table generating device 161 for the identified independent component as a w-valued sequence transmitted from the transmitting device 121.

Incidentally, regarding the transform function m(•) used for modulation and transmission, the transmitting device 124 may transform the acquired code

e₁,e₂, . . . , e_{N}

by a transform function m(•) defined as

m(x)=rᵢ(xεRᵢ)

by a representative value rᵢεRᵢ determined in advance for each of the partial intervals Rᵢ into

m(e₁),m(e₂), . . . , m(e_{N}),

and modulate the transformed code for transmission.

In addition, when simple bit sequences are transmitted, a technique to use a Chebyshev map of the 16th order or 64th order may be used if 16QAM or 64QAM is used. In this case, several bit sequences are bundled to be transformed into a w-valued sequence and one of points used for phase/amplitude modulation is assigned as a representative value rᵢ.

According to the technique, Chebyshev maps of various orders can appropriately be used.

Various components in the present invention can be realized by combining a computer (having a CPU or ALU in charge of computation or control and a RAM or the like in charge of storage) provided in a communication equipment and a communication circuit. Particularly processing to generate a code table can be realized by various numeric operations and thus, a code table generating device can be realized by causing a CPU to execute a program for performing such processing.

### INDUSTRIAL APPLICABILITY

According to the present invention, a communication system and a communication method which transmit and receive a digital signal of no less than a binary by using a code table in which chaotic map is used and an independent component analysis, and a computer readable information recording medium recording a program that causes a computer to realize these communication system and method can be provided.

This application is based upon and claims the benefit of priority from the Japanese Patent Application No. 2006-355101 (filed on Dec. 28, 2006), the entire contents of which being incorporated herein by reference as long as statutes of designated states permit.

1. A communication system (101) that encodes a bit sequence to be transmitted by
chaotic map T(•) with a predetermined interval [L, U] defined as a domain and a range,
an inverse function F⁻¹(•) of a partial function F(•) of the chaotic map T(•) with a first partial interval in the predetermined interval defined as the domain and the predetermined interval as the range, the first partial interval being a partial interval in which the chaotic map T(•) becomes bijective map,
an inverse function G⁻¹(•) of a partial function G(•) of the chaotic map T(•) with a second partial interval in the predetermined interval defined as the domain and the predetermined interval as the range, the second partial interval being a partial interval in which the chaotic map T(•) becomes bijective map, and
an applying function A(•, •) defined as
A(0,x)=F⁻¹(x);
A(1,x)=G⁻¹(x)
for bit values of 0 and 1
and has a transmitting device (121) and a receiving device (141), wherein each of the transmitting device (121) and the receiving device (141) has a code table generating device (161),
(a) the code table generating device (161) each, comprising:
a boundary value computation unit (162) that computes, for each of any bit sequences of a length N, boundary values
v_{U}=A(b_{N}, . . . A(b₂,A(b₁,U)) . . . );
v_{L}=A(b_{N},A(b₂,A(b₁,L)) . . . )
for the bit sequence
b₁,b₂, . . . , b_{N;}
a numeric value selection unit (163) that selects a numeric value v contained in an interval whose upper limit is one of the computed boundary values v_{U} and v_{L} and whose lower limit is the other;
a sequence computation unit (164) that computes a sequence
a₁,a₂, . . . , a_{N}
from the selected numeric value v by a recurrence formula
a₁=v;
aᵢ₊₁=T(aᵢ) (1≦i<N); and
a code table storage unit (165) that stores a code table for associating a code for the bit sequence
b₁,b₂, . . . , b_{N}
with each of any bit sequences of the length N as the computed sequence
a₁,a₂, . . . , a_{N}
(b) the transmitting device (121), comprising:
an input unit (122) that accepts input of a bit sequence
s₁,s₂, . . . , s_{N}
of the length N to be transmitted;
a code acquisition unit (123) that acquires a code
e₁,e₂, . . . , e_{N}
for the bit sequence
s₁,s₂, . . . , s_{N}
in the code table stored in the code table generating device (161) of the transmitting device (121); and
a transmitting unit (124) that modulates and transmits the acquired code
e₁,e₂, . . . , e_{N}, and
(c) the receiving device (141), comprising:
a receiving unit (142) that receives and demodulates signals including codes transmitted from the transmitting device (121) by a plurality of antennas for and demodulated;
an independent component analysis unit (143) that performs an independent component analysis of signals received by the plurality of antennas and demodulated into a plurality of independent components;
a correlation identifying unit (144) that determines a maximum value of correlation of each of the plurality of independent components with each code contained in the code table stored in the code table generating device (161) of the receiving device (141) and identifies the independent component whose maximum value of the correlation is the largest as a signal including codes transmitted from the transmitting device (121); and
an output unit (145) that outputs a bit sequence associated with the maximum value of correlation determined in the code table stored in the code table generating device (161) for the identified independent component as a bit sequence transmitted from the transmitting device (121).

2. The communication system (101) according to claim 1, wherein
the predetermined interval [L, U] is [−1, 1],
the chaotic map T(•) is defined as
T(x)=2x²−1
by a second-order Chebyshev map, and
the inverse function F⁻¹(•) and the inverse function G⁻¹(•) are defined as
F⁻¹(y)=[(y+1)/2]^{1/2};
G⁻¹(y)=−[(y+1)/2]^{1/2}

3. The communication system (101) according to claim 1, wherein
the predetermined interval is [−1, 1],
the chaotic map T(•) is defined as
T(x)=2x²−1
by a second-order Chebyshev map, and
the inverse function F⁻¹(•) and the inverse function G⁻¹(•) are defined as
F⁻¹(y)=−[(y+1)/2]^{1/2};
G⁻¹(y)=[(y+1)/2]^{1/2}

4. The communication system (101) according to claim 1, wherein
the transmitting unit (124) in the transmitting device (121) transforms the acquired code
e₁,e₂, . . . , e_{N}
by a transform function m(•) defined as
m(x)=1 (x≧0);
m(x)=−1 (x<0)
into
m(e₁),m(e₂), . . . , m(e_{N})
and modulates and transmits the transformed code.

5. The communication system (101) according to claim 1, wherein
the transmitting unit (124) in the transmitting device (121) transforms the acquired code
e₁,e₂, . . . , e_{N}
by a transform function m(•) defined as
m(x)=−1 (x≧0);
m(x)=1 (x<0)
into
m(e₁),m(e₂), . . . , m(e_{N}),
and modulates and transmits the transformed code.

6. A communication system (101) that encodes a w-valued sequence to be transmitted by:
chaotic map T(•), which is w(w≧2)-order Chebyshev polynomial with a predetermined interval [−1, 1] defined as a domain and a range;
an inverse function Fᵢ⁻¹(•) of a partial function Fᵢ(•) of the chaotic map T(•) with an i(0≦i<w)-th partial interval Rⱼ in the predetermined interval defined as the domain and the predetermined interval as the range, for w mutually prime partial intervals R₀, R₁, . . . , R_{w-1} (∪ᵢ₌₀^{w-1}Rᵢ=[−1, 1]) in which the chaotic map T(•) becomes bijective map; and
an applying function A(•, •) defined as
A(0,x)=F₀⁻¹(x);
A(1,x)=F₁⁻¹(x);
. . . ;
A(i,x)=Fᵢ⁻¹(x);
. . . ;
A(w−1,x)=F_{w-1}⁻¹(x);
for w values 0, 1, . . . , i, . . . , w−1 and has a transmitting device (121) and a receiving device (141), wherein each of the transmitting device (121) and the receiving device (141) has a code table generating device (161),
(a) the code table generating device (161) each, comprising:
a boundary value computation unit (162) that computes, for each of any w-valued sequences of a length N, boundary values
v₋₁=A(b_{N}, . . . A(b₂,A(b₁,−1)) . . . );
v₁=A(b_{N}, . . . A(b₂,A(b₁,1)) . . . )
for the w-valued sequence
b₁,b₂, . . . , b_{N};
a numeric value selection unit (163) that selects a numeric value v contained in an interval whose upper limit is one of the computed boundary values v₁ and v₋₁ and whose lower limit is the other;
a sequence computation unit (164) that computes a sequence
a₁,a₂, . . . , a_{N}
from the selected numeric value v by a recurrence formula
a₁=v;
aᵢ₊₁=T(aᵢ) (1≦i<N); and
a code table storage unit (165) that stores a code table for associating each of any w-valued sequences of the length N with a code for the w-valued sequence
b₁,b₂, . . . , b_{N}
as the computed sequence
a₁,a₂, . . . , a_{N}
(b) the transmitting device (121), comprising:
an input unit (122) that accepts input of a w-valued sequence
s₁,s₂, . . . , s_{N}
of the length N to be transmitted;
a code acquisition unit (123) that acquires a code
e₁,e₂, . . . , e_{N}
for the w-valued sequence
s₁,s₂, . . . , s_{N}
in the code table stored in the code table generating device (161) of the transmitting device (121); and
a transmitting unit (124) that modulates and transmits the acquired code
e₁,e₂, . . . , e_{N}, and
(c) the receiving device (141), comprising:
a receiving unit (142) that receives signals including codes transmitted from the transmitting device (121) by a plurality of antennas and demodulated;
an independent component analysis unit (143) that performs an independent component analysis of signals received by the plurality of antennas into a plurality of independent components and demodulated;
a correlation identifying unit (144) that determines a maximum value of correlation of each of the plurality of independent components with each code contained in the code table stored in the code table storage unit (161) of the receiving device (141) and identifies the independent component whose maximum value of the correlation is the largest as a signal including codes transmitted from the transmitting device (121); and
an output unit (145) that outputs a w-valued sequence associated with the maximum value of correlation determined in the code table stored in the code table generating device (161) for the identified independent component as a w-valued sequence transmitted from the transmitting device (121).

7. The communication system (101) according to claim 6, wherein
the transmitting unit (124) in the transmitting device (121) transforms the acquired code
e₁,e₂, . . . e_{N}
by a transform function m(•) defined as
m(x)=rᵢ(xεRᵢ)
by a representative value rᵢεRᵢ determined in advance for each of the partial intervals Rᵢ into
m(e₁),m(e₂), . . . , m(e_{N}),
and modulates the transformed code for transmission.

8. The communication system (101) according to claim 1 or 6, wherein
the transmitting device (121) transmits a signal to be transmitted by dividing it into portions of the length N and
the receiving device (141) determines the maximum value of correlation of each of the plurality of independent components with the code by dividing the independent component into sequences of the length N to identify the independent component with the largest sum of the determined maximum values of correlation as a signal including codes transmitted from the transmitting device (121).

9. A communication method performed in a communication system (101) that encodes a bit sequence to be transmitted by
chaotic map T(•) with a predetermined interval [L, U] defined as a domain and a range,
an inverse function F⁻¹(•) of a partial function F(•) of the chaotic map T(•) with a first partial interval in the predetermined interval defined as the domain and the predetermined interval as the range, the first partial interval being an interval in which the chaotic map T(•) becomes bijective map,
an inverse function G⁻¹(•) of a partial function G(•) of the chaotic map T(•) with a second partial interval in the predetermined interval defined as the domain and the predetermined interval as the range, the second partial interval being an interval in which the chaotic map T(•) becomes bijective map, and
an applying function A(•, •) defined as
A(0,x)=F⁻¹(x);
A(1,x)=G⁻¹(x)
for bit values of 0 and 1
and has a transmitting device (121) and a receiving device (141): wherein each of the transmitting device (121) and the receiving device (141) has a code table generating device (161),
(a) the code table generating device (161) each comprising a boundary value computation unit (162), a numeric value selection unit (163), a sequence computation unit (164) and a code table storage unit (165); wherein
the communication method comprises in the transmitting device (121) and the receiving device (141):
a boundary value computation step of the boundary value computation unit (162) computing, for each of any bit sequences of a length N, boundary values
v_{U}=A(b_{N}, . . . A(b₂,A(b₁,U)) . . . );
v_{L}=A(b_{N}, . . . A(b₂,A(b₁,L)) . . . )
for the bit sequence
b₁,b₂, . . . , b_{N};
a numeric value selection step by the numeric value selection unit (163) selecting a numeric value v contained in an interval whose upper limit is one of the computed boundary values v_{U} and v_{L} and whose lower limit is the other;
a sequence computation step of the sequence computation unit (164) computing a sequence
a₁,a₂, . . . , a_{N}
from the selected numeric value v by a recurrence formula
a₁=v;
aᵢ₊₁=T(aᵢ) (1≦i<N); and
a code table storage step of the code table storage unit (165) storing a code table for associating each of any bit sequences of the length N with a code for the bit sequence
b₁,b₂, . . . , b_{N}
as the computed sequence
a₁,a₂, . . . , a_{N,}
(b) the transmitting device (121) comprising an input unit (122), a code acquisition unit (123), and a transmitting unit (124), wherein
the communication method comprises in the transmitting device (121):
an input step of the input unit (122) accepting input of a bit sequence
s₁,s₂, . . . , s_{N}
of the length N to be transmitted;
a code acquisition step of the code acquisition unit (123) acquiring a code
e₁,e₂, . . . , e_{N}
for the bit sequence
s₁,s₂, . . . , s_{N}
in the code table stored in the code table generating device (161) of the transmitting device (121); and
a transmitting step of the transmitting unit (124) modulating and transmitting the acquired code
e₁,e₂, . . . , e_{N}; and
(c) the receiving device (141) comprising a receiving unit (142), an independent component analysis unit (143), a correlation identifying unit (144), and an output unit (145), wherein
the communication method comprises in the receiving device (141):
a receiving step of the receiving unit (142) receiving and demodulating signals that include codes transmitted from the transmitting device (121) by a plurality of antennas;
an independent component analysis step of the independent component analysis unit (143) performing an independent component analysis of signals received by the plurality of antennas and demodulated into a plurality of independent components;
a correlation identifying step of the correlation identifying unit (144) determining a maximum value of correlation of each of the plurality of independent components with each code contained in the code table stored in the code table generating device (161) of the receiving device (141) and identifying the independent component whose maximum value of the correlation is the largest as a signal including codes transmitted from the transmitting device (121); and
an output step of the output unit (145) outputting a bit sequence associated with the maximum value of correlation determined in the code table stored in the code table generating device (161) for the identified independent component as a bit sequence transmitted from the transmitting device (121).

10. The communication method according to claim 9, wherein
the predetermined interval [L, U] is [−1, 1],
the chaotic map T(•) is defined as
T(x)=2x²−1
by a second-order Chebyshev map, and
the inverse function F⁻¹(•) and the inverse function G⁻¹(•) are defined as
F⁻¹(y)=[(y+1)/2]^{1/2};
G⁻¹(y)=−[(y+1)/2]^{1/2}

11. The communication method according to claim 9, wherein
the predetermined interval is [−1, 1],
the chaotic map T(•) is defined as
T(x)=2x²−1
by a second-order Chebyshev map, and
the inverse function F⁻¹(•) and the inverse function G⁻¹(•) are defined as
F⁻¹(y)=−[(y+1)/2]^{1/2};
G⁻¹(y)=[(y+1)/2]^{1/2}

12. The communication method according to claim 9, wherein
in the transmitting step of the transmitting device (121), the acquired code
e₁,e₂, . . . , e_{N}
is transformed by a transform function m(•) defined as
m(x)=1 (x≧0);
m(x)=−1 (x<0)
into
m(e₁),m(e₂), . . . , m(e_{N})
and modulated and transmitted.

13. The communication method according to claim 9, wherein
in the transmitting step of the transmitting device (121), the acquired code
e₁,e₂, . . . , e_{N}
is transformed by a transform function m(•) defined as
m(x)=−1 (x≧0);
m(x)=1 (x<0)
into
m(e₁),m(e₂), . . . , m(e_{N}),
and modulated for transmission.

14. A communication method performed in a communication system (101) that encodes a bit sequence to be transmitted by:
chaotic map T(•), which is w(w≧2)-order Chebyshev polynomial with a predetermined interval [−1, 1] defined as a domain and a range;
an inverse function Fᵢ⁻¹(•) of a partial function Fᵢ(•) of the chaotic map T(•) with an i(0≦i<w)-th partial interval Rⱼ in the predetermined interval defined as the domain and the predetermined interval as the range, for w mutually prime partial intervals R₀, R₁, . . . , R_{w-1} (∪ᵢ₌₀^{w-1}Rᵢ=[−1, 1]) in which the chaotic map T(•) becomes bijective map; and
an applying function A(•, •) defined as
A(0,x)=F₀⁻¹(x);
A(1, x)=F₁⁻¹(x);
. . . ;
A(i,x)=Fᵢ⁻¹(x);
. . . ;
A(w−1,x)=F_{w-1}⁻¹(x);
for w values 0, 1, . . . , i, . . . , w−1 and has a transmitting device (121) and a receiving device (141), wherein each of the transmitting device (121) and the receiving device (141) has a code table generating device (161),
(a) the code table generating device (161) each comprising a boundary value computation unit (162), a numeric value selection unit (163), a sequence computation unit (164) and a code table storage unit (165), wherein
the communication method comprises in the transmitting device (121) and the receiving device (141):
a boundary value computation step of the boundary value computation unit (162) computing, for each of any bit sequences of a length N, boundary values
v_{U}=A(b_{N}, . . . A(b₂,A(b₁,U)) . . . );
v_{L}=A(b_{N}, . . . A(b₂,A(b₁,L)) . . . )
for the w-valued sequence
b₁,b₂, . . . , b_{N};
a numeric value selection step of the numeric value selection unit (163) selecting a numeric value v contained in an interval whose upper limit is one of the computed boundary values v_{U} and v_{L} and whose lower limit is the other;
a sequence computation step of the sequence computation unit (164) computing a sequence
a₁,a₂, . . . , a_{N}
from the selected numeric value v by a recurrence formula
a₁=v;
aᵢ₊₁=T(aᵢ) (1≦i<N); and
a code table storage step of the code table storage unit (165) storing a code table for making each of any bit sequences of the length N correspond to a code for the w-valued sequence
b₁,b₂, . . . , b_{N}
as the computed sequence
a₁,a₂, . . . , a_{N};
(b) the transmitting device (121) comprising an input unit (122), a code acquisition unit (123), and a transmitting unit (124), wherein
the communication method comprises in the transmitting device (121):
an input step of the input unit (122) accepting input of a w-valued sequence
s₁,s₂, . . . , s_{N}
of the length N to be transmitted;
a code acquisition step of the code acquisition unit (123) acquiring a code
e₁,e₂, . . . , e_{N}
for the w-valued sequence
s₁,s₂, . . . , s_{N}
in the code table stored in the code table generating device (161) of the transmitting device (121); and
a transmitting step of the transmitting unit (124) modulating and transmitting the acquired code
e₁,e₂, . . . , e_{N}; and
(c) the receiving device (141) comprising a receiving unit (142), an independent component analysis unit (143), a correlation identifying unit (144), and an output unit (145), wherein
the communication method comprises in the receiving device (141):
a receiving step of the receiving unit (142) receiving signals that include codes transmitted from the transmitting device (121) by a plurality of antennas and demodulated;
an independent component analysis step of the independent component analysis unit (143) performing an independent component analysis of signals received by the plurality of antennas and demodulated into a plurality of independent components;
a correlation identifying step of the correlation identifying unit (144) determining a maximum value of correlation of each of the plurality of independent components with each code contained in the code table stored in the code table storage unit (161) of the receiving device (141) and identifying the independent component whose maximum value of the correlation is the largest as a signal including codes transmitted from the transmitting device (121); and
an output step of the output unit (145) outputting a w-valued sequence associated with the maximum value of correlation determined in the code table stored in the code table generating device (161) for the identified independent component as a w-valued sequence transmitted from the transmitting device (121).

15. The communication method according to claim 14, wherein
in the transmitting step of the transmitting device (121), the acquired code
e₁,e₂, . . . , e_{N}
is transformed by a transform function m(•) defined as
m(x)=rᵢ(xεRᵢ)
by a representative value rᵢεRᵢ determined in advance for each of the partial intervals Rᵢ into
m(e₁),m(e₂), . . . , m(e_{N}),
and modulated and transmitted.

16. The communication method according to claim 9 or 14, wherein
the transmitting device (121) transmits a signal to be transmitted by dividing it into portions of the length N and
the receiving device (141) determines the maximum value of correlation of each of the plurality of independent components with the code by dividing the independent component into sequences of the length N to identify the independent component with the largest sum of the determined maximum values of correlation as a signal including codes transmitted from the transmitting device (121).

17. A computer readable information recording medium recording a program causing a computer to function as each unit of a transmitting device (121) in a communication system (101) according to claim 1 or 6.

18. A computer readable information recording medium recording a program causing a computer to function as each unit of a receiving device (141) in a communication system (101) according to claim 1 or 6.

19. A computer readable information recording medium recording a program causing a first computer to function as each unit of a transmitting device (121) in a communication system (101) according to claim 1 or 6 and a second computer to function as each unit of a receiving device (141) in the communication system (101) according to claim 1 or 6.
